(19) United States
(12) Patent Application Publication
(10) Pub. No.: US 2008/0235018 A1
(43) Pub. Date: Sep. 25, 2008

(54) Method and System for Determing the Topic of a Conversation and Locating and Presenting Related Content

(75) Inventors: Josephus Hubertus Eggen, Eindhoven (NL); Gerrit Hollemans, Eindhoven (NL); Bartel Marinus Van de Sluis, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIKKE PHILIPS ELECTRONIC,N.V.

(21) Appl. No.: 10/597,323

(22) PCT Filed: Jan. 17, 2005
(86) PCT No.: PCT/IB2005/050191

§ 371 Date: Jul. 20, 2006

Related U.S. Application Data
(60) Provisional application No. 60/537,808, filed on Jan. 20, 2004.

(51) Int. Cl. G10L 15/04

(52) U.S. Cl. 704/251; 704/E15.001

(57) ABSTRACT

A method and system are disclosed for determining the topic of a conversation and obtaining and presenting related content. The disclosed system provides a “creative inspirator” in an ongoing conversation. The system extracts keywords from the conversation and utilizes the keywords to determine the topic(s) being discussed. The disclosed system then conducts searches to obtain supplemental content based on the topic(s) of the conversation. The content can be presented to the participants in the conversation to supplement their discussion. A method is also disclosed for determining the topic of a text document including transcripts of audio tracks, newspaper articles, and journal papers.

The present invention relates to analyzing, searching and retrieving content, and more particularly, to a method and system for obtaining and presenting content that is relevant to an ongoing conversation.

Professionals in search of new and creative ideas have always sought inspiring environments in which to brainstorm, make new associations, and to think in different ways in order to develop new insights and ideas. People try to interact socially and philosophize with each other in a stimulating environment even during time spent in leisure activities. In all of these situations, it is helpful to have a creative inspirator who is involved in the conversation and who has a deep knowledge of the subject matter and the power to inject novel associations that lead to new avenues of discussion. In today's networked world, it would be equally valuable to have an intelligent network play the role of a creative inspirator.

To accomplish this, the intelligent system would need to monitor the conversation and understand what topic(s) were being discussed without requiring explicit input from the participants. Based on the conversation, the system would search for and retrieve content and information, including related words and topics, that could suggest new avenues of discussion. Such a system would be suitable for use in various environments, including living rooms, trains, libraries, meeting rooms, and waiting rooms.

A method and system are disclosed for determining the topic of a conversation and obtaining and presenting content that is related to the conversation. The disclosed system provides a “creative inspirator” in an ongoing conversation. The system extracts keywords from the conversation and utilizes the keywords to determine the topic(s) being discussed. The disclosed system then conducts searches within an intelligent, networked environment to obtain content based on the topic(s) of the conversation. The content can be presented to the participants in the conversation to supplement their discussion.

A method is also disclosed for determining the topic of a text document including transcripts of audio tracks, newspaper articles, and journal papers. The topic determination method uses hypernym trees of keywords and wordstems extracted from the text to identify parents in the hypernym trees that are common to two or more of the extracted words. Hyponym trees of selected common parents are then used to determine the common parents with the highest coverage of keywords. These common parents are then selected to represent the topic of the text document.

A more complete understanding of the present invention, as well as further features and advantages of the present invention, will be obtained by reference to the following detailed description and drawings.

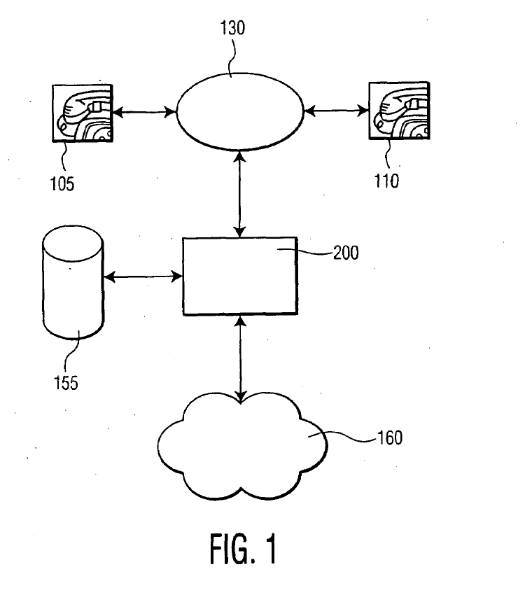

FIG. 1 illustrates an expert system for obtaining and presenting content to supplement an ongoing conversation;

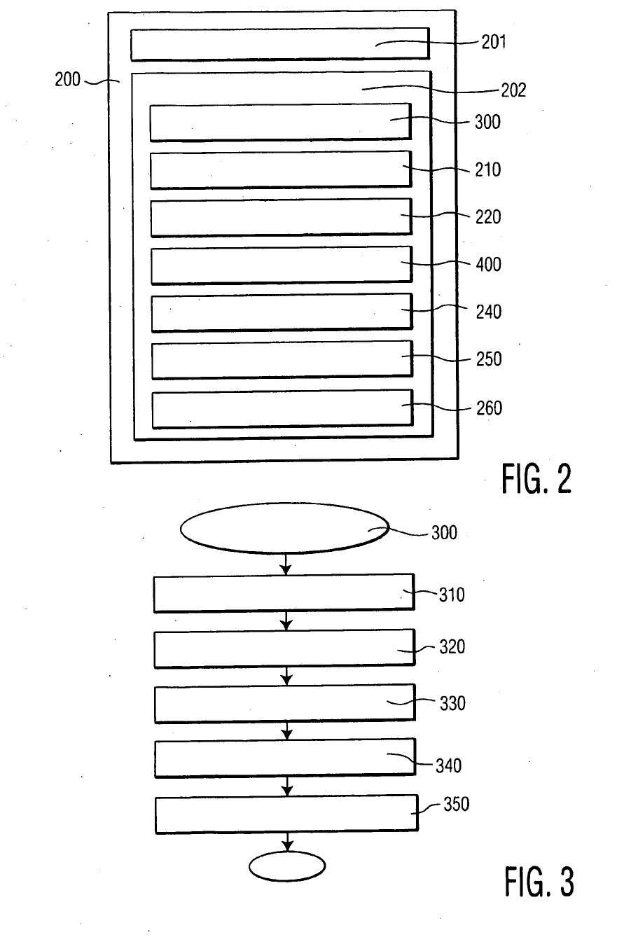

FIG. 2 is a schematic block diagram of the expert system of FIG. 1;

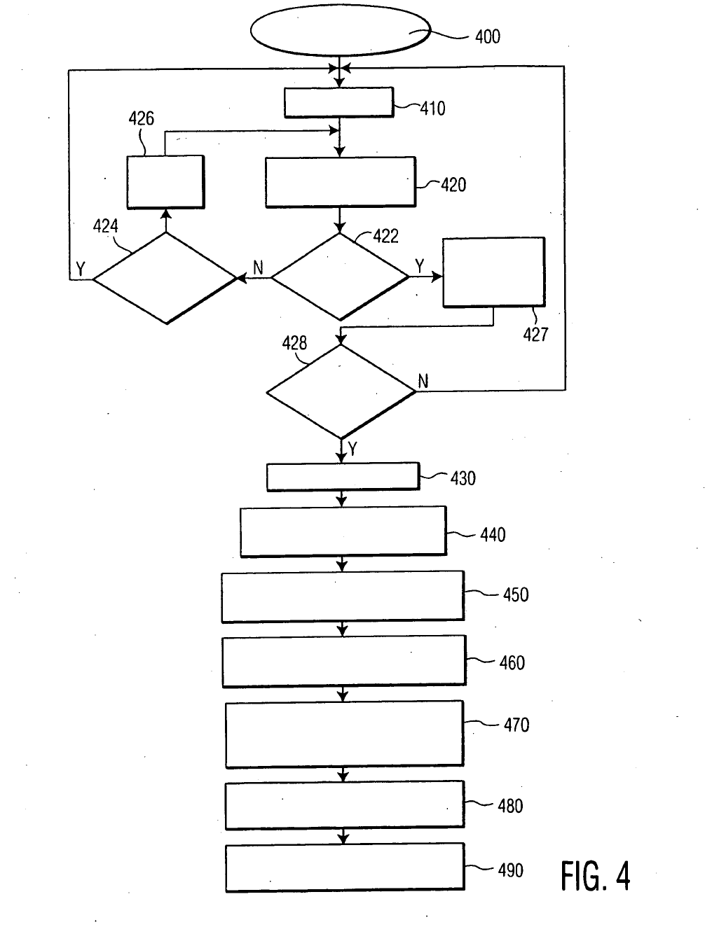

FIG. 3 is a flowchart describing an exemplary implementation of the expert system process of FIG. 2 incorporating features of the present invention;

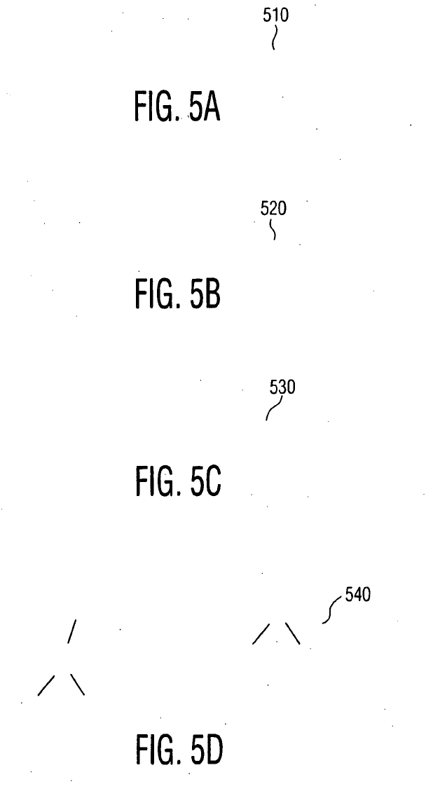

FIG. 4 is a flowchart describing an exemplary implementation of a topic finding process incorporating features of the present invention;

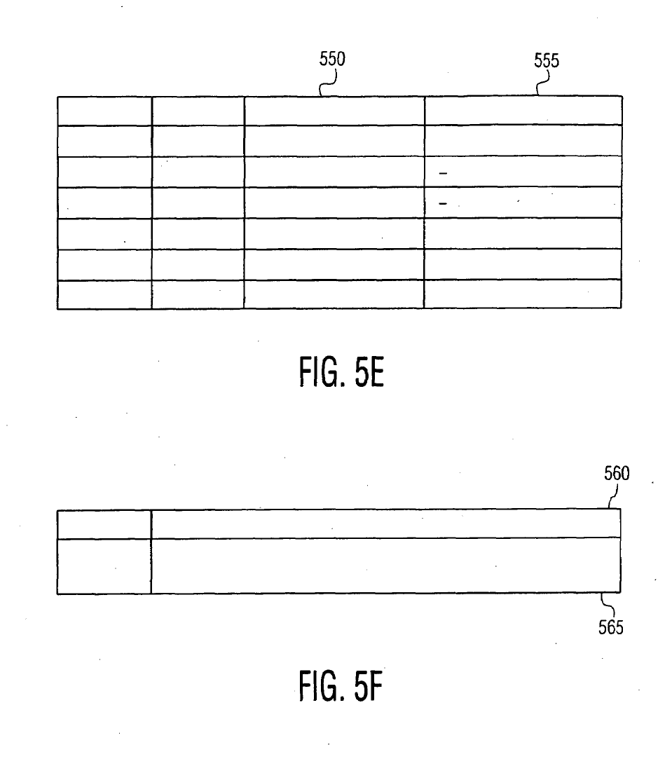

FIG. 5A illustrates a transcript of a conversation;

FIG. 5B shows the set of keywords for the transcript of FIG. 5A;

FIG. 5C shows the wordstems for the set of keywords of FIG. 5B;

FIG. 5D illustrates portions of the hypernym trees for the wordstems of FIG. 5C;

FIG. 5E shows the common parents and level-5 parents for the hypernym trees of FIG. 5D; and

FIG. 5F illustrates a flattened portion of the hyponym trees for the selected level-5 parents of FIG. 5D.

FIG. 1 illustrates an exemplary network environment in which an expert system 200, discussed below in conjunction with FIG. 2, incorporating features of the present invention can operate. As shown in FIG. 1, two individuals employing telephone devices 105, 110 communicate over a network, such as the Public Switched Telephone Network (PSTN) 130. According to one aspect of the present invention, the expert system 200 extracts keywords from the conversation between the participants 105, 110 and determines the topic of the conversation based on the extracted keywords. While the participants are communicating over a network in the exemplary embodiment, the participants could alternatively be located in the same location, as would be apparent to a person of ordinary skill in the art.

According to a further aspect of the invention, the expert system 200 can identify supplemental information that may be presented to one or more of the participants 105, 110 to provide additional information, inspire the participants 105, 110 or encourage a new avenue of discussion. The expert system 200 can search for supplemental content, for example, that is stored on a networked environment (such as the Internet) 160 or in a local database 155 utilizing the identified conversation topic(s). The supplemental content is then presented to the participants 105, 110 to supplement their discussion. In the exemplary implementation, the expert system 200 presents the content in the form of audio information, including speech, sounds, and music, since the conversation exists only in a verbal form. The content can also be presented to a user, for example, in the form of text, video or images, using a display device, as would be apparent to a person of ordinary skill in the art.

FIG. 2 is a schematic block diagram of the expert system 200 incorporating features of the present invention. As is known in the art, the methods and apparatus discussed herein may be distributed as an article of manufacture that itself comprises a computer-readable medium having computer-readable code means embodied thereon. The computer-readable program code means is operable, in conjunction with a computer system such as central processing unit 201, to carry out all or some of the steps to perform the methods or create the apparatuses discussed herein. The computer-readable medium may be a recordable medium (e.g., floppy disks, hard drives, compact disks, or memory cards) or may be a transmission medium (e.g., a network comprising fiber-optics, the world-wide web 160, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic medium or height variations on the surface of a compact disk.

Memory 202 will configure the processor 201 to implement the methods, steps, and functions disclosed herein. The memory 202 could be distributed or local and the processor 201 could be distributed or singular. The memory 202 could be implemented as an electrical, magnetic or optical memory, or any combination of these or other types of storage devices. The term “memory” should be construed broadly enough to encompass any information able to be read from or written to an address in the addressable space accessed by processor 201.

As shown in FIG. 2, the expert system 200 includes an expert system process 300, discussed below in conjunction with FIG. 3, a speech recognition system 210, a keyword extractor 220, a topic finder process 400, discussed below in conjunction with FIG. 4, a content finder 240, a content presentation system 250, and a keyword and tree database 260. Generally, the expert system process 300 extracts keywords from the conversation, utilizes the keywords to determine the topic(s) being discussed and identifies supplemental content based on the topic(s) of the conversation.

The speech recognition system 210 captures the conversation of one or more participants 105, 110 and converts the audio information to text in the form of a complete or partial transcript, in a known manner. If the participants 105, 110 in the conversation are located in the same geographic area and if the speech of the participants 105, 110 overlaps in time, then recognizing their speech may be difficult. In one implementation, beam-forming technology using microphone arrays (not shown) may be utilized to improve speech recognition by picking up a separate speech signal from each individual 105, 110. Alternatively, each participant 105, 110 could wear a lapel microphone to pick up the speech of the individual speakers. If the participants 105, 110 to the conversation are in separate areas, then recognizing their speech can be accomplished without the use of the microphone arrays or lapel microphones. The expert system 200 may utilize one or more speech recognition system(s) 210.

Keyword extractor 220 extracts keywords from the transcript of the audio track of each participant 105, 110, in a known manner. As each keyword is extracted, it may optionally be time-stamped with the time it was spoken. (Alternatively, the keyword may be time-stamped with the time it was recognized or the time it was extracted.) The timestamps may optionally be used to relate the content discovered to the portion of the conversation that contained the keyword.

As discussed further below in conjunction with FIG. 4, the topic finder 400 derives a topic from one or more of the keywords extracted from the conversation using a language model. The content finder 240 utilizes the conversation topics discovered by the topic finder 400 to search content repositories including local databases 155, the worldwide web 160, electronic encyclopedias, a user's personal media collection or, optionally, radio and television channels (not shown) for related information and content. In alternative embodiments, the content finder 240 could directly utilize the keywords and/or wordstems to conduct the search. For example, a worldwide web search engine such as Google.com could be used to conduct a broad search of websites containing information that may be relevant to the conversation. In a similar manner, related keywords or related topics could be searched for and sent to the content presentation system for presentation to the participants in the conversation. A history of the keywords, related keywords, topics, and related topics may also be maintained and presented.

The content presentation system 250 presents the content in a variety of formats. In a telephone conversation, for example, the content presentation system 250 will present an audio track. In other embodiments, the content presentation system 250 may present other types of content including text, graphics, images, and videos. In this example, the content presentation system 250 utilizes a tone to signal the participants 105, 110 in the conversation that new content is available. The participants 105, 110 then signal the expert system 200 to present (play) the content by using an input mechanism, such as voice commands or dual tone multi-frequency (DTMF) tone(s) from the telephone.

FIG. 3 is a flow chart describing an exemplary implementation of the expert system process 300. As shown in FIG. 3, the expert system process 300 performs speech recognition to generate a transcript of the conversation (step 310), extracts keywords from the transcript (step 320), determines the topic(s) of the conversation by analyzing the extracted keywords (step 330), in a manner discussed further below in conjunction with FIG. 4, searches for supplemental content obtained in an intelligent, networked environment 160 based on the conversation topic(s) (step 340), and presents the discovered content (step 350) to the participants 105, 110 in the conversation.

For example, if the participants 105, 110 are discussing the weather, the system 200 may inspire the participants 105, 110 by presenting information on the weather forecast, or will present historical weather information; if they are discussing plans for a vacation in Australia, the system 200 may present photographs and nature sounds of Australia; and if they are simply discussing what to have for dinner, the system 200 may present pictures of entrees along with their recipes.

FIG. 4 is a flow chart describing an exemplary implementation of the topic finder process 400. Generally, topic finder 400 determines the topic of a variety of content including transcripts of verbal conversations, text-based conversations (e.g. instant messaging), lectures, and newspaper articles. As shown in FIG. 4, the topic finder 400 initially reads a keyword from the set of one or more keywords (step 410) and then determines the wordstem for each of the selected keywords (step 420). At step 422, a test is performed to determine if a wordstem was found for the selected keyword. If it is determined during step 422 that a wordstem was not found, a test is performed to determine if all word types were checked for the selected keyword (step 424). If it is determined during step 424 that all word types were checked for the given keyword, a new keyword is read (step 410). If it is determined during step 424 that all word types were not checked, then the word type of the selected keyword is changed to a different word type (step 426) and step 420 is repeated with the new word type.

If the wordstem test (step 422) determines that a wordstem was found for the selected keyword, then the wordstem is added to the list of wordstems (step 427) and a test is performed to determine if all the keywords were read (step 428). If it is determined during step 428 that all the keywords were not read, then step 410 is repeated; otherwise, the process continues with step 430.

During step 430, the hypernym trees for all senses (semantic meanings) of all words in the wordstem set are determined. A hypernym is the generic term used to designate a whole class of specific instances i.e., Y is a hypernym of X if X is a type of Y. For example, ‘car’ is a kind of ‘vehicle,’ so ‘vehicle’ is a hypernym of ‘car.’ A hypernym tree is a tree of all hypernyms of a word up to the highest level in the hierarchy, including the word itself.

A comparison is then made between all pairs of hypernym trees to find a common parent at a specific level (or lower) in the hierarchy during step 440. A common parent is the first hypernym in a hypernym tree that is the same for two or more words in the keyword set. It is noted that a level-5 parent, for instance, is an entry in the hierarchy at the fifth level, four steps down from the highest level in the hierarchy, that is either a hypernym of a common parent or a common parent by itself. The level selected to be the specified level should have an appropriate level of abstraction such that the topic is not so specific that no relevant content can be found and not so abstract that the content discovered is not relevant to the conversation. In the present embodiment, level-5 is selected as the specified level in the hierarchy.

A search is then conducted to find the corresponding level-S parent(s) for all common parent(s) (step 450). The hyponym trees are then determined for all the senses of the level-5 parents (step 460). A hyponym is the specific term used to designate a member of a class X. X is a hyponym of Y if X is a type of Y i.e., ‘car’ is a type of ‘vehicle’,’ so ‘car’ is the hyponym of ‘vehicle.’ A hyponym tree is a tree of all hyponyms of a word down to the lowest level in the hierarchy, including the word itself. For each of the hyponym trees, the number of words that are common to the hyponym tree and the set of keywords are counted (step 470).

A list of the level-5 parents whose hyponym tree covers (contains) more than two words in the wordstem set is then compiled during step 480. Finally, the one or two level-S parents that have the highest coverage (contain the most words from the wordstem set) are then selected (step 490) to represent the topic(s) of the conversation. In one alternative embodiment of the topic finder process 400, if common parents exist for senses of keywords utilized to select previous topics, then steps 440 and/or steps 450 can ignore common parents of the senses of the keyword that were not utilized in selecting the topic based on a particular sense of the keyword. This will eliminate unnecessary processing and will result in more stable topic selection.

In a second alternative embodiment, steps 450 through 480 are skipped and step 490 selects the topic based on the common parents of previous topics and the common parents discovered in step 440. Similarly, in a third alternative embodiment, steps 450 through 480 are skipped and step 490 selects the topic based on previous topics and the common parents discovered in step 440. In a fourth alternative embodiment, steps 460 through 480 are skipped and step 490 selects topics based on all the specific-level parents determined in step 450.

For example, consider the sentence 510 in FIG. 5A from the transcript of a conversation. The keyword set 520 for this sentence is shown in FIG. 5B (computers/N, trains/N, vehicles/N, cars/N) where/N signifies that the preceding word is a noun. For this keyword set, the wordstems 530 (computer/N, train/N, vehicle/N, car/N) would be determined (step 420; FIG. 5C). The hypernym tree 540 would then be determined (step 430), a portion of which is illustrated in FIG. 5D. For this example, FIG. 5E shows the common parents 550 and level-5 parents 555 for the pairs of trees listed in the first two fields and FIG. 5F shows a flattened part 560, 565 of the hyponym trees of level-S parents device) and (conveyance, transport), respectively.

In the present example, the number of words in the hyponym tree of (device) that are also in the wordstem set is determined to be two: ‘computer’ and ‘train.’ Similarly, the number of words in the hyponym tree of (conveyance, transport) that are also in the set is determined to be three: ‘train,’ ‘vehicle,’ and ‘car.’ The coverage of (device) is therefore ½; the coverage of (conveyance, transport) is ¾. At step 480, both level-5 parents would be reported and the topic would be set to (conveyance, transport) (step 490) since it has the highest associated word count.

The content finder 240 would then search for content in a local database 155 or in an intelligent, networked environment 160 based on this topic (conveyance, transport) of the conversation in a known manner. For example, a google Internet search engine can be requested to perform a worldwide search utilizing the topic, or a combination of topic(s), discovered in the conversation. A list of the content found, and/or the content itself, is then sent to the content presentation system 250 for presentation to the participants 105, 110.

The content presentation system 250 presents the content to the participants 105, 110 in an active or passive manner. In the active mode, the content presentation system 250 interrupts the conversation to present the content. In the passive mode, the content presentation system 250 alerts the participants 105, 110 to the availability of content. The participants 105, 110 may then access the content in an on-demand manner. In the present example, the content presentation system 250 alerts the participants 105, 110 in the telephone conversation with an audio tone. The participants 105, 110 can then select which content is to be presented and specify the time at which it is to be presented utilizing DTMF signals generated by the telephone keypad. The content presentation system 250 would then play the selected audio track at the specified time.

It is to be understood that the embodiments and variations shown and described herein are merely illustrative of the principles of this invention and that various modifications may be implemented by those skilled in the art without departing from the scope and spirit of the invention

1. A method for providing content to a conversation between at least two people, comprising the steps of:
extracting one or more keywords from said conversation;
obtaining content based on said keywords; and
presenting said content to one or more of said people in said conversation.

2. The method of claim 1, further comprising the step of determining a topic of said conversation based on said extracted keywords and wherein said obtaining content step is based on said topic.

3. The method of claim 1, further comprising the step of performing speech recognition to extract said keywords from said conversation wherein said conversation is a verbal conversation.

4. The method of claim 1, further comprising the step of determining wordstems of said keywords and wherein said obtaining content step is based on said wordstems.

5. The method of claim 1, wherein said presented content includes said one or more keywords, one or more related keywords, or a history of said keywords.

6. The method of claim 2, wherein said presented content includes said topic, one or more related topics or a history of topics.

7. The method of claim 1, wherein said obtaining content step further comprises the step of performing a search of one or more content repositories.

8. The method of claim 2, wherein said obtaining content step further comprises the step of performing a search of the Internet based on said topic.

9. A method to determine a topic, comprising the steps of:
determining one or more common parents of senses of one or more keywords using hypernym trees of said senses;
determining at least one word count of the number of words common to said keywords and a hyponym tree of senses of one of said common parents; and
selecting at least one of said common parents based on said at least one word count.

10. The method of claim 9, wherein said step of determining said one or more common parents is restricted to a specific level or lower in the hierarchy of said hypernym tree.

11. The method of claim 10, further comprising the step of determining one or more parents at said specific level for at least one of said common parents and wherein said common parents of said determining at least one word count step are said specific level parents.

12. The method of claim 9, wherein said selecting step selects said at least one of said common parents based on the sense of a keyword utilized in a previous topic selection.

13. The method of claim 11, wherein said selecting step selects said at least one of said common parents based on the sense of a keyword utilized in a previous topic selection.

14. A system for providing content to a conversation between at least two people, comprising:
a memory; and
at least one processor, coupled to the memory, operative to:
extract one or more keywords from said conversation;
obtain content based on said keywords; and
present said content to one or more of said people in said conversation.

15. The system of claim 14, wherein said processor is further configured to determine a topic of said conversation based on said extracted keywords and obtain said content based on said topic.

16. The system of claim 14, wherein said processor is further configured to perform speech recognition to extract said keywords from said conversation wherein said conversation is a verbal conversation.

17. The system of claim 14, wherein said processor is further configured to determine wordstems of said keywords and obtain said content based on said wordstems.

18. The system of claim 14, wherein said presented content includes said one or more keywords, one or more related keywords, or a history of said keywords.

19. The system of claim 15, wherein said presented content includes said topic, one or more related topics or a history of topics.

20. A system for determining a topic, comprising:
a memory; and
at least one processor, coupled to the memory, operative to:
determine one or more common parents of senses of one or more keywords using hypernym trees of said senses;
determine at least one word count of the number of words common to said keywords and a hyponym tree of senses of one of said common parents; and
select at least one of said common parents based on said at least one word count.

21. The system of claim 20, wherein said processor is further configured to determine said one or more common parents is restricted to a specific level or lower in the hierarchy of said hypernym tree.

22. The system of claim 21, wherein said processor is further configured to determine one or more parents at said specific level for at least one of said common parents and determine said at least one word count of said common parents using said specific level parents.

23. A method to determine a topic, comprising the steps of:
determining one or more common parents of senses of one or more keywords using hypernym trees of said senses; and
selecting at least one of said common parents based on at least one of said common parents and one or more previous common parents.

24. The method of claim 23, wherein said one or more previous common parents are one or more previous topics.

25. The method of claim 23, wherein said selecting step selects said at least one of said common parents based on the sense of a keyword utilized in a previous topic selection.

26. A method to determine a topic, comprising the steps of:
determining one or more common parents of senses of one or more keywords using hypernym trees of said senses; and
selecting one or more parents at a specific level of said one or more common parents.
